(19) United States
(12) Patent Application Publication
(10) Pub. No.: US 2026/0067633 A1
(43) Pub. Date: Mar. 5, 2026

(54) RETRIEVAL AUGMENTED NEURAL FIELD FOR GENERATING SPATIAL AUDIO

(71) Applicant: Mitsubishi Electric Research Laboratories, Inc., Cambridge, MA (US)

(72) Inventors: Yoshiki Masuyama, Tokyo (JP); Gordon Wichern, Cambridge, MA (US); François G Germain, Quincy, MA (US); Christopher Ick, New York City, NY (US); Jonathan Le Roux, Arlington, MA (US)

(73) Assignee: Mitsubishi Electric Research Laboratories, Inc., Cambridge, MA (US)

(21) Appl. No.: 19/020,032

(22) Filed: Jan. 14, 2025

(30) Foreign Application Priority Data
Aug. 27, 2024 (JP) 2024-145438

(51) Int. Cl. H04S 7/00; H04S 1/00

(52) U.S. Cl. CPC H04S 7/307; H04S 1/00; H04S 7/302; H04S 2420/01

(57) ABSTRACT

Systems, methods, software, and devices are disclosed herein that transform anechoic audio signals into spatialized audio signals. An audio processing method includes identifying a target sound source direction and a reference head related transfer function (HRTF) associated with a target subject and obtaining one or more retrieved HRTFs from an HRTF dataset based at least on the reference HRTF and the target sound source direction. The method continues with executing a neural field model to produce an output based on an input. Example input includes the one or more retrieved HRTFs and the target sound source direction, and example output includes a predicted HRTF. The anechoic audio signal may then be processed based at least on the predicted HRTF to produce a spatialized audio signal.

### TECHNICAL FIELD

Aspects of the disclosure are related to the field of audio processing, and in particular, to spatialized audio technology.

### BACKGROUND

Spatialized audio refers to an audio effect that gives the impression to a listener that sound is arriving from a particular direction and/or location, when a headset, speaker, or other such sound source is proximate to the listener's ears. Users increasingly encounter spatialized audio in the context of virtual and augmented reality environments, multi-media applications, gaming experiences, and the like, where immersive experiences are popular and in demand.

Spatialized audio is created by configuring an impulse response (IR) filter to modify anechoic audio signals based on one or more head related transfer functions (HRTFs) and/or room impulse responses (RIRs). The resulting spatialized audio signal output by the IR filter drives audio components that create the sound waves heard by a listener. The IR filter physically changes frequency and phase characteristics of the anechoic audio signal in accordance with the desired HRTF(s) or RIR(s) such that, when the sound waves arrive at a listener's ears, they create the impression that the sound originated from a desired sound source direction.

HRTFs model the filtering of sound as it travels between a sound source and both ears of a human listener. HRTFs are important for immersive audio in augmented/virtual reality among other applications and allow convincing simulation of sound sources from different physical locations. Unfortunately, HRTFs are difficult to collect in practice, and the ideal HRTF is often quite different between listeners due to anatomical differences in the shape of the ears and head. Thus, recently HRTF personalization, which can quickly adapt existing HRTFs to a new listener, and HRTF upsampling, which spatially interpolates HRTF measurements from a small set of directions to any possible source direction, have become important areas of study for improving immersive audio experiences.

### SUMMARY

Technology is disclosed herein that improves spatialized audio with state-of-the-art upsampling and personalization of HRTFs based on neural fields, parameter-efficient fine-tuning, and retrieval augmented generation (RAG). In an implementation, an audio processing method includes identifying a target sound source direction and a reference head related transfer function (HRTF) associated with a target subject and obtaining one or more retrieved HRTFs from an HRTF dataset based at least on the reference HRTF and the target sound source direction. The method continues with executing a neural field model to produce an output based on an input. Example input includes the one or more retrieved HRTFs and the target sound source direction, and example output includes a second HRTF. The anechoic audio signal may then be processed based at least on the second HRTF to produce a spatialized audio signal.

The neural field may be implemented in the context of computing hardware and software systems such as personal computers, server computers, mobile phones, gaming consoles, multi-media devices, and the like, which output spatialized audio via headphones, headsets, speakers, or other such peripherals. Other suitable contexts include the peripherals themselves such as headphones capable of executing the neural network. Indeed, the neural network may be employed to produce spatialized audio for a variety of applications such as virtual and/or augmented reality, gaming, and multi-media applications, to name just a few.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a spatialized audio system in an implementation.

FIG. 2 illustrates an audio processing method in an implementation.

FIG. 3 illustrates an application of the audio processing method of FIG. 2 with respect to the spatialized audio system of FIG. 1 in an implementation.

FIG. 4 illustrates a training method in an implementation.

FIG. 5 illustrates an application of the training method of FIG. 4 with respect to the spatialized audio system of FIG. 1 in an implementation.

FIGS. 6A-6B illustrate a neural network architecture in an implementation.

FIGS. 7A-7B illustrate a transform-average-concatenate (TAC) architecture in an implementation.

FIG. 8 illustrates a computing system suitable for implementing the various operational environments, architectures, processes, scenarios, and sequences discussed below with respect to the other Figures.

### DETAILED DESCRIPTION

Head-related transfer functions (HRTFs) characterize how the ears receive sound from a point or direction in space. They are essential to many applications, including telepresence systems and virtual reality technologies. As HRTFs depend on anthropometric characteristics (i.e., the dimensions of body parts such as the pinnae, head, and upper torso), they vary from person to person, and individual HRTFs are thought necessary for consistent audio immersion. In this case, the sound reaching the ears is the result of convolving the source audio with the HRTF given the source direction. In practice, only a finite number of directions can be measured. To handle sources from any direction, the HRTFs must be spatially up-sampled.

Straightforward upsampling corresponds to approximating to the closest measurement. However, the measurement density required to achieve immersion, combined with the resources needed for quality measurements makes this intractable at scale. Recently, machine learning approaches have gained increasing attention since they can flexibly exploit anthropometric features and HRTFs for multiple subjects. Despite recent progress, challenges remain regarding how to exploit a variable number of HRTF measurements and how to estimate HRTFs at arbitrary directions.

To tackle these challenges, several works have leveraged the neural field, or implicit neural representation, where the HRTF is represented as a function of the sound source direction. Neural fields have been developed in computer vision to reconstruct 3D scenes from multiple 2D views and have been applied to spatial audio modeling. In HRTF modeling by neural fields, prior works have shown the potential to estimate the magnitude response of the HRTFs, or directly estimate the modal components of an HRTF. One approach even provides for efficiently personalizing HRTFs for new listeners using a small number of measurements based on parameter efficient fine-tuning, which efficiently updates only a subset of neural field parameters when adapting to a new listener.

The technology disclosed herein improves upon these approaches for HRTF interpolation by incorporating retrieval augmented generation (RAG). RAG is a common technique used in large language models that improves the accuracy of the generated text by incorporating knowledge obtained from an external database. The disclosed system retrieves multiple subjects whose HRTF magnitude and interaural time difference (ITD) are close to those of a target subject at the measured directions. The retrieved HRTF magnitude and ITD at the target direction are fed into a neural field in addition to the direction and subject-specific parameters for personalization.

At a high level, the proposed system provides a personalized and spatially upsampled impulse response in an application such as virtual/augmented reality, telepresence, etc. There are two inputs to the overall system: (1) subject, and (2) target sound source direction. The subject (or listener ID), is the person whom the HRTFs will be personalized for, i.e., they will be adapted to their unique anatomical features such as head and car shape, head shape, etc. The target sound source direction (typically specified in terms of azimuth and elevation angles), is the direction at which to simulate the arrival of sound from a sound source. The target sound source direction could come from a simulated environment that a person is interacting with in a virtual/augmented reality experience. For example, if a user is working remotely, but is being simulated as if they are present in a meeting, the target source direction would be the direction of the person currently speaking in the simulated meeting room.

Since the HRTFs required to simulate accurate locations from all possible directions cannot be practically collected, they may be spatially upsampled from a small number of actual HRTFs (e.g., a dataset containing HRTFs measured at a few directions). Every subject has their own set of subject specific parameters (which are small number of weight and bias parameters) used to adapt the neural field model to their specific anatomical features. For each subject, an HRTF dataset stores a small number of HRTFs collected at some directions for the given subject. However, because the size of the HRTF dataset for the target subject is small, and may cover only a few directions, the HRTF retrieval block performs the RAG process by finding in a database of HRTFs from multiple listeners, HRTFs that have sound source directions close to the target sound source direction, but that are also similar to the target subject's HRTF(s).

More specifically, given a new subject, the set of measured sound source direction HRTFs for the new subject are compared to the HRTF dataset. The HRTF dataset includes multiple subjects with HRTFs densely measured at a large number of directions. Alternatively, or in addition, some or all of the HRTFs in the dataset may be estimates, produced by a neural field, of the HRTFs of the reference subjects in the dataset.

Using a metric calculation, those subjects in the HRTF dataset with similar HRTFs to the new subject may be retrieved. This means that these subjects likely have similar car and head shape to the target subject. In practice the metric calculation compares two HRTFs in terms of their Euclidean or Manhattan distance of two features: (1) the magnitude spectra of the HRTF at each car, and (2) the ITD between the two cars. Given the set of retrieved subjects most similar to the new subject, HRTF selection (sampling) may be performed that selects the HRTFs from the retrieved subjects at the target sound source direction. This set of HRTFs forms a set of retrieved HRTFs.

A neural field model takes the subject specific parameters, retrieved HRTFs, and target sound source direction as input, and outputs the HRTF magnitude spectra for both the left and right ears and the interaural time difference (ITD) that quantifies the time difference between when a sound at the target sound source direction reaches the two ears of the listener. Given the magnitude spectra and ITD, the process of applying the HRTF to an anechoic sound signal (e.g., the person speaking in the simulated meeting example) to be spatially rendered follows an established pipeline. First, minimum phase compensation is used to convert the estimated magnitude spectra at each car into a time domain finite impulse response (FIR) filter. Next, the estimated FIR filters are shifted to compensate ITD, and convolution is used to apply the shifted FIR filters to the anechoic audio signal in order to obtain the spatialized audio signal. (It may be appreciated that the neural field may alternatively output parameters that could be used to configure an infinite impulse response (IIR) filter in addition to—or as an alternative to—FIRs.)

More specifically, the neural field converts the retrieved HRTFs from subjects with similar characteristics to the HRTF from the target subject at the measured sound source direction(s) for the target subject. The retrieved HRTFs, which may be stored as time domain filters or computed using another process (e.g., a neural field), first go through a feature extraction process that converts the time domain filters to the magnitude spectra at each car and the interaural time difference between the cars. The retrieved HRTFs, along with the target sound source direction (specified in terms of azimuth and elevation angles), and the subject specific parameters (which are weight and bias updates for the neural field network), are combined to predict the personalized magnitude spectra and ITD for the target subject at the target direction.

The architecture of the proposed neural field may include a convolutional encoder that encodes the magnitude spectra for each retrieved subject. In addition, an ITD encoder transforms the retrieved ITDs into an embedding using random Fourier features (RFFs) together with a sound source direction. The embedding is concatenated with the encoded magnitude, which constructs a sequence of embeddings for each retrieved subject. Then, two custom sub-blocks, an intra-subject bidirectional long short-term memory (BLSTM) and an inter-subject transform-average-concatenation (TAC) block, are applied multiple times alternately. The intra-subject BLSTM focuses on modeling the relation between embeddings of each retrieved subject by applying BLSTM to each embedding sequence. The inter-subject TAC aggregates information from the processed embeddings of multiple retrieved subjects. The output of the last sub-block is split into magnitude-related embeddings and ITD-related embedding. The resulting embeddings are fed into a convolution decoder to predict the magnitude spectra in the log scale. Meanwhile, the ITD-related embedding is processed by a multi-layer perceptron (MLP) to predict ITD which, with the predicted magnitude spectra, may be used to configure a filter that converts anechoic signals to spatialized signals.

The TAC block discussed above provides for combining the retrieved subject HRTFs from each of the K subjects. Except for an average calculation, the TAC block processes the embedding for each subject separately. First, the embedding for each subject is passed to two dense layers (fully connected layers with activation functions), resulting in two processed embeddings for each of K subjects. The TAC block then takes an average of one of the processed embeddings produced by one of the two dense layers for all of the K subjects. The average embedding is concatenated with the other embedding produced by the other dense layer for a given subject and is passed to an additional dense layer. The additional dense layer leverages a small amount of subject specific parameters that depend on the target and retrieved subjects. The subject specific parameters modify the output of the layer. Low-rank adaptation (LoRA) approach may be used, although it may be appreciated that there are multiple ways to implement a network with subject specific parameters.

Training the neural field may be accomplished by using an HRTF dataset from multiple subjects. Each example of the HRTF dataset includes (1) the ID of the subject, (2) sound source direction, and (3) the corresponding time-domain HRTF at the sound source direction. Given a training example with a training subject ID and training sound source direction, one or more of the HRTFs for the training subject at one or more comparison sound source directions different from the training sound source direction are used to determine a subset of retrieved subjects whose HRTFs at the same one or more comparison sound source directions are similar to those of the training subject. The HRTFs at the training sound source direction for the retrieved subjects are retrieved from the dataset. Then, the training subject ID, the training sound source direction, and the retrieved HRTFs are fed into the neural field together with the subject specific parameters for the training subject and the retrieved subjects to predict the magnitude spectra and ITD. The parameters of the neural field and the subject specific parameters are updated during training to minimize a loss function which encourages the predicted magnitude spectra and ITD to be close to the magnitude spectra and ITD of the corresponding training time-domain HRTF of the training subject at the training sound source direction. Root mean square error (RMSE) may be used by the loss function for the magnitude spectra, and the robust mean absolute error (MAE) for the ITD.

The neural field may be adapted for a new subject by using a small number of HRTFs collected from the new subject. In this case, only a portion of the neural field is updated using the new HRTFs. Some parameters of the field are frozen and only the subject specific parameters are updated using parameter efficient fine-tuning. For parameter-efficient fine-tuning, the low-rank adaptation (LoRA) approach may be used, although any approach suitable for fine-tuning models may be employed. Each weight matrix can be represented as the sum of a subject-dependent matrix that itself is represented as the product of two low-rank matrices, and a subject-independent matrix, which is beneficial as the number of subject-specific parameters that need to be stored is greatly reduced. Then, given a specific subject, only the weight matrices computed as the low-rank product of matrices corresponding to the target and/or retrieved subjects will be used when updating the neural network parameters.

It may be appreciated that the technology disclosed herein to transform anechoic audio signals into spatialized audio signals applies as well to the transformation of audio signals having some existing spatialization into audio signals with an increased amount of spatialization. Indeed, the anechoic audio signals referred to throughout may inherently include some spatialized characteristics. That is, since an anechoic signal that is entirely free from any reflection or echo is difficult (if not impossible) to achieve in practice, the term “anechoic” is intended to refer to audio signals that-if not purely anechoic—are substantially less-spatialized than the spatialized audio signals produced in accordance with the disclosed implementations. Thus, the term “anechoic audio signal” as used throughout means both audio signals that are purely anechoic, as well as audio signals that are demonstrably anechoic relative to the spatialized audio signals that are produced in accordance with the disclosed implementations.

It may also be appreciated that, while discussed herein with respect to HRTFs, the disclosed technology is not limited to HRTFs. Rather, the disclosed technology may be applied as well with respect to room impulse responses (RIRs) and the like.

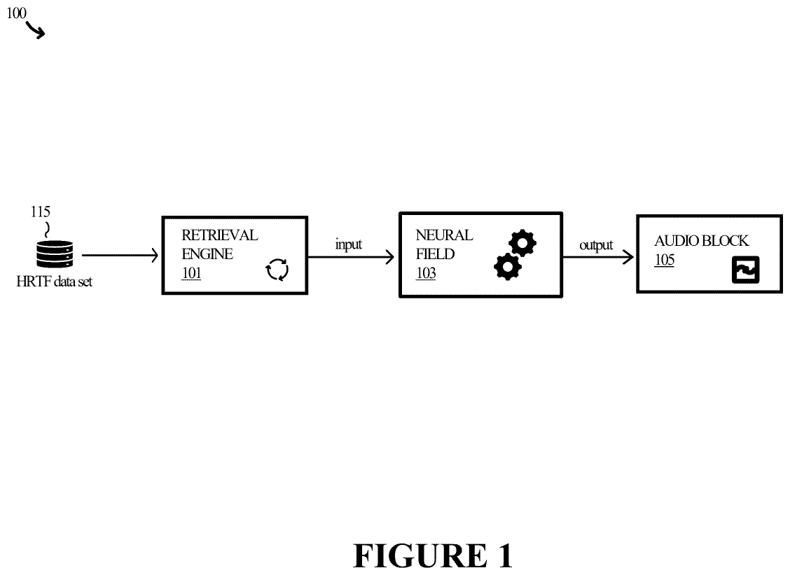

Turning now to the figures, FIG. 1 illustrates spatialized audio system 100 in an implementation, referred to hereafter as system 100. The elements of system 100 may each be implemented in software or firmware executed by the circuitry of one or more processing devices on a single computing device or distributed across multiple computing devices. Alternatively, or in addition, some or all of the functionality provided by any of the elements of system 100 may be implemented entirely via application-specific integrated circuits or other such special purpose processing devices.

System 100 includes neural field 103, and audio block 105. Retrieval engine 101 is operatively coupled with neural field 103, while neural field 103 is operatively coupled with audio block 105. Said coupling may include outputting certain values that are supplied as input to the next element. For example, the output of retrieval engine 101 is supplied as input to neural field 103, while the output of neural field 103 is supplied as input to audio block 105.

Retrieval engine 101 is representative of one or more software, firmware, and/or hardware components capable of searching an HRTF dataset on the basis of an HRTF associated with a target subject, as well as a sound source direction. Neural field 103 is representative of an artificial neural network or other such machine learning algorithm capable of processing retrieved HRTFs, a subject ID, and a target direction as input and producing a predicted HRTF as output. Audio block 105 is representative of one or more software, firmware, and/or hardware components capable of converting anechoic audio signals to spatialized audio signals based directly or indirectly on the predicted HRTFs output by neural field 103.

Retrieval engine 101, neural field 103, and audio block 105 may each be implemented in software or firmware executed by the circuitry of one or more processing devices on a single computing device or distributed across multiple computing devices. Alternatively, or in addition, some or all of the functionality provided by any of retrieval engine 101, neural field 103, and audio block 105 may be implemented entirely via application-specific integrated circuits or other such special purpose processing devices.

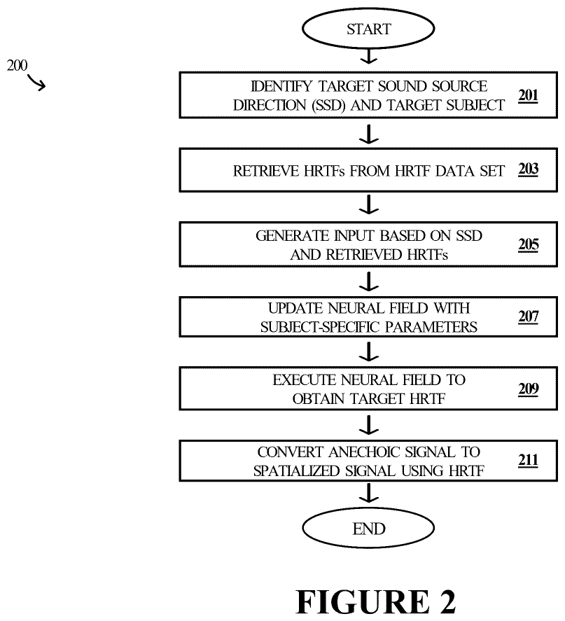

FIG. 2 illustrates an audio processing method 200 employed at inference time using system 100 to generate spatialized audio. Audio processing method 200 may be implemented in program instructions in the context of the software and/or firmware elements of system 100 such as retrieval engine 101, neural field 103, and audio block 105. The program instructions, when executed by one or more processing devices of one or more suitable computing devices, direct the one or more computing devices to operate as follows, referring parenthetically to the steps of FIG. 2 and in the singular to a computing device for the sake of clarity.

In operation, the computing device identifies a target sound source direction, and a reference head related transfer function (HRTF) associated with a target subject (step 201). The target sound source direction is representative of the direction of a desired sound source relative to a listener position, e.g., the position of the target subject. The reference HRTF is representative of an HRTF that was measured or otherwise collected for the target subject in association with a reference sound source direction other than the target sound source direction. For example, the reference HRTF may be an HRTF measured or developed for the left ear, whereas the target sound source direction might be from the right (or from any other different direction).

The computing device proceeds to retrieve one or more subjects and HRTFs from an HRTF dataset based at least on the reference HRTF, the reference direction, and the target sound source direction (step 203). While a single reference HRTF is referenced herein for the sake of clarity, it may be appreciated that more than one HRTF may be used. For example, multiple HRTFs for the new subject could be used to retrieve similar HRTFs from the HRTF dataset. The subjects are retrieved by first searching for subjects in the HRTF dataset based on the similarity between the reference HRTF and the HRTF of the subjects for the reference direction. In other words, the HRTF dataset is searched for similar subjects. Then, the HRTFs for those retrieved subjects at the target sound source direction are retrieved.

The retrieved HRTFs and the target sound source direction are used to generate input for a neural field model (step 205). The neural field model is updated based on subject specific parameters associated with the target subject and the retrieved subjects (step 207), and then the computing device executes the neural field model to process the supplied input and produce output that includes a second—or predicted—HRTF (step 209). The predicted HRTF is used to convert an anechoic signal to one or more spatialized signals (step 211). In some cases, the predicted HRTF may be used to generate both channels of a dual-channel spatialized signal.

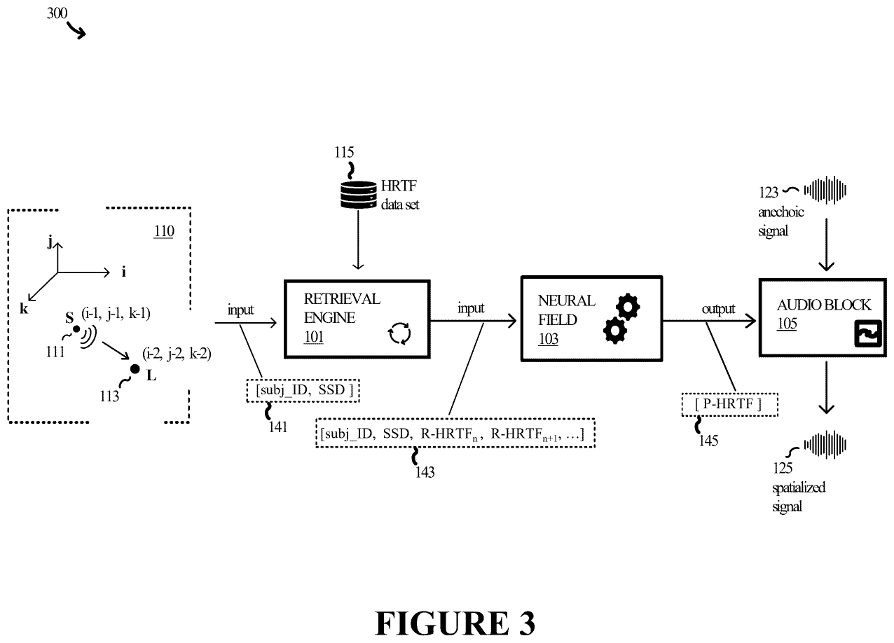

FIG. 3 illustrates an application of audio processing method 200 with respect to the elements of system 100 in FIG. 1. In operation, retrieval engine 101 receives input data 141 that includes a target sound source direction and a subject identifier (ID). The target sound source direction may indicate direction in terms of a position of a sound source 111 relative to a listener position 113 in a virtual or augmented reality environment 110. The relative position may be indicated in terms of elevation and azimuth angles determined based on the two positions, or in simpler terms such as left and right, forward and rear, and the like. The relative position may be supplied by an upstream application or component such as a virtual/augmented reality application, a multi-media application, a gaming application, or the like, capable of dynamically determining the direction as the relative position changes in real-time. In other cases, the direction may be a static value that is pre-determined and pre-programmed.

Retrieval engine 101 retrieves a reference HRTF from HRTF dataset 115 based on the identity of the target subject in input data 117. The reference HRTF and the target sound source direction are then used to search for and retrieve other HRTFs and their associated subjects from HRTF dataset 115. Retrieval engine 101 generates input 143 for neural field 103 that includes vectorized representations of the retrieved HRTFs and the target sound source direction. Retrieval engine 101 also supplies the subject ID and/or subject-specific parameters to neural field model 103.

Neural field model 103 processes the input 143 and produces output 145 that includes a predicted HRTF. The predicted HRTF may include a magnitude spectra component and an interaural time difference (ITD) component that are used by audio block 105 to configure a finite impulse response (FIR) filter. Audio block 105 passes anechoic signal 123 through the FIR filter to produce spatialized signal 125. As mentioned, audio block 105 may also use the reference HRTF to produce a second spatialized signal in some embodiments.

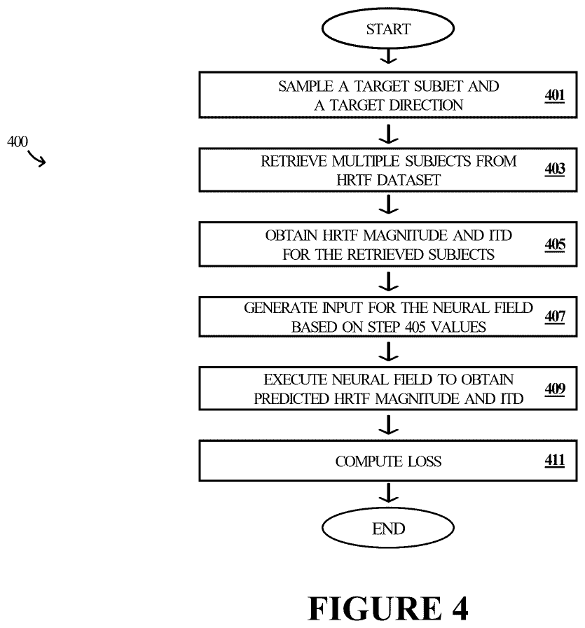

FIG. 4 illustrates training method 400 employed at training time to train neural field 103 of system 100. It may be appreciated that training process 400, while generally representative of how a neural network is trained, is highly simplified and provides merely a snapshot into the training process with respect to a single training cycle and a single input instance. Training method 400 may be implemented in program instructions in the context of the software and/or firmware elements of system 100 such as retrieval engine 101 and neural field 103. The program instructions, when executed by one or more processing devices of one or more suitable computing devices, direct the one or more computing devices to operate as follows, referring parenthetically to the steps of FIG. 4 and in the singular to a computing device for clarity.

In operation, the computing device samples a target subject and a target direction (step 401). Next, the computing device retrieves multiple subjects from an HRTF dataset (step 403). This may be accomplished by sampling one or more directions from D directions. In some cases, the sampled set may include a pre-defined set of directions. In addition, the sampled set may include the target direction, although the target direction is not required. A similarity metric is then computed that represents the similarity between the target subject and the other subjects in the dataset. The similarity metric may be calculated based on the ITD and/or HRTF magnitude at the directions sampled above. Based on the computed similarity, K subjects are retrieved from the dataset. The subjects may be selected based on a K-NN search, stochastic sampling, or other suitable techniques.

The computing device proceeds to obtain the HRTF magnitude and the ITD for the retrieved subjects (step 405). This is accomplished by computing the HRTF magnitude and the ITD at the target direction for the K retrieved subjects. In some implementations, the measured distance may be assumed to be the same across subjects in the HRTF dataset.

Using the computed HRTF magnitude and ITD values, the computing device generates the input for the neural field (step 407). The generated input includes: 1) the target direction sampled in step 401, the HRTF magnitude and ITD values for the K retrieved subjects, and 3) subject specific parameters of the neural field that are switched based on the target and retrieved subjects. Such parameters may be considered inputs to the neural field because they vary based on the target subject sampled in step 401.

The computing device then executes the neural network based on the generated input to predict the HRTF magnitude and the ITD for the target subject and the target direction (step 409). The predicted magnitude and ITD and a ground-truth magnitude and ITD are used by the computing device to compute the loss (step 411). The ground-truth magnitude and ITD may be calculated for the target subject and the target direction using the corresponding time-domain HRTF in the dataset. A variety of loss functions may be employed to penalize the difference between the true and predicted HRTF magnitude and ITD such as Euclidean distance for the magnitude and Manhattan distance for the ITD.

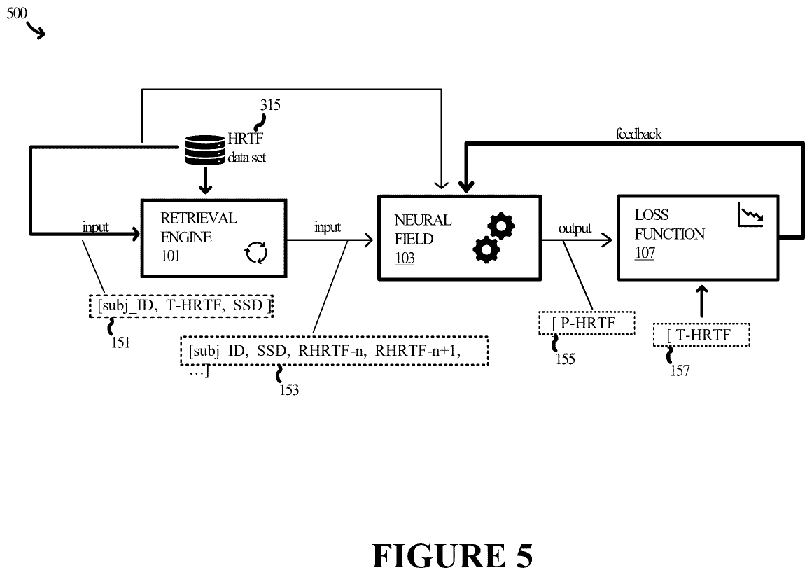

FIG. 5 illustrates an application of training method 400 with respect to the elements of system 100 in FIG. 1. In operation, retrieval engine 101 selects a target HRTF from HRTF database 115. The HRTF includes a magnitude spectra component and an ITD component, both of which hold values that represent measurements taken with respect to a subject identify associated with the HRTF. Thus, the target HRTF represents a ground-truth value with which the output of the neural network can be evaluated.

Next, retrieval engine 101 retrieves a set of other HRTFs from the HRTF database. Retrieval engine 101 generates input data 151 based on the retrieved HRTFs, as well as a target sound source direction that is associated with the target HRTF in the database. Other data may accompany the inputs such as subject specific parameters or they may be provided to the neural field model in some other manner.

The subject specific parameters are used to update a portion of neural field model 103. Neural field model 103 processes the input data and generates output 155 that includes a predicted HRTF. The predicted HRTF includes a magnitude spectra component and an ITD component, one or both of which may be fed to loss function 107. Loss function 107 computes a difference between the two and provides feedback to neural field 103 or some other suitable component of system 100. As mentioned, the output of the loss function is used to determine whether the model has been sufficiently trained with respect to the target HRTFs supplied as training data.

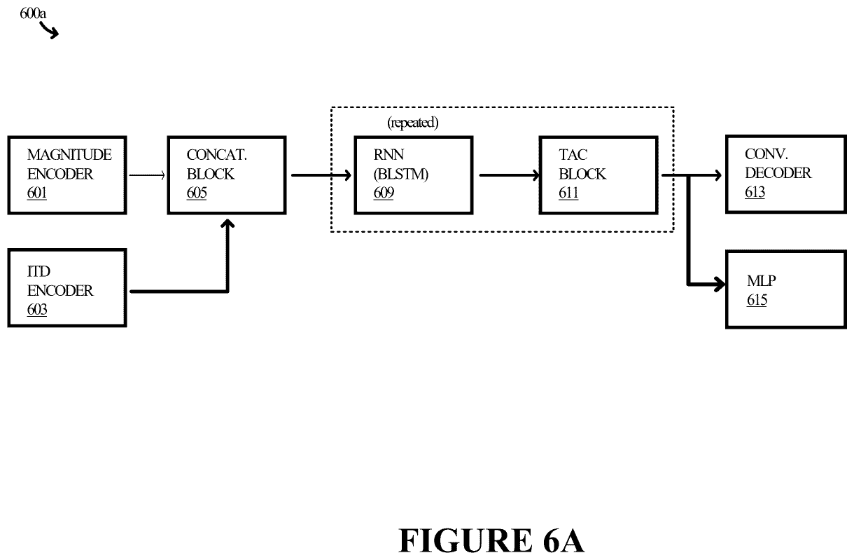

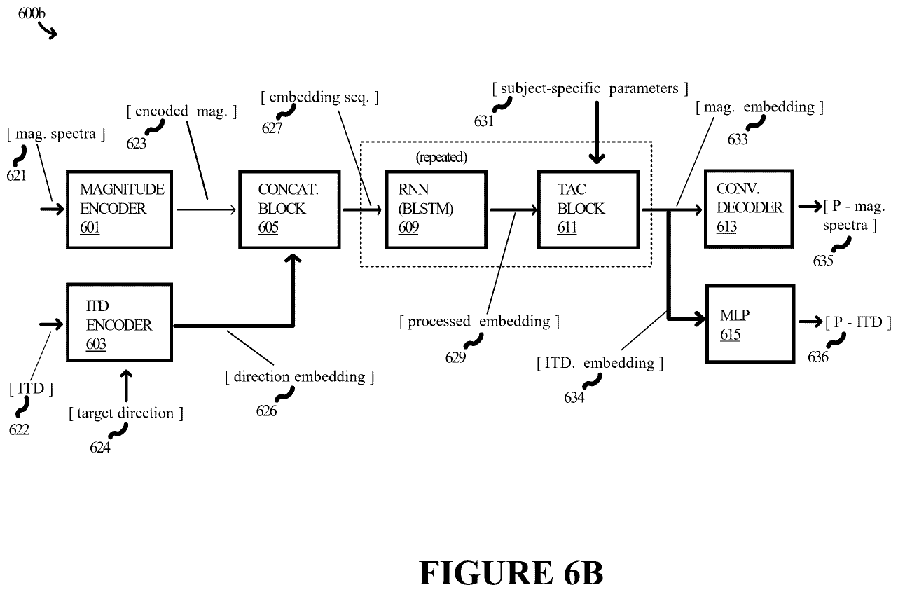

FIG. 6A illustrates network architecture 600 in an embodiment that is representative of a suitable architecture for implementing neural field 103. The elements of network architecture 600 may each be implemented in software or firmware executed by the circuitry of one or more processing devices on a single computing device or distributed across multiple computing devices. Alternatively, or in addition, some or all of the functionality provided by any of the elements of network architecture 600 may be implemented entirely via application-specific integrated circuits or other such special purpose processing devices.

Network architecture 600 includes magnitude encoder 601, ITD encoder 603, concatenation block 605, recurrent neural network (RNN) 609, transform-average-concatenate (TAC) block 611, convolutional decoder 613, and multi-layer perceptron (MLP) 615. Magnitude encoder 601 and ITD encoder 603 are operatively coupled with concatenation block 605. Concatenation block 605 is operatively coupled with RNN 609, while RNN 609 is operatively coupled with TAC block 611. TAC block 611 is operatively coupled with convolutional decoder 613 and MLP 615. Said coupling may include outputting certain values that are supplied as input to the next element. For example, the output of RNN block 609 is supplied as input to TAC block 611, while the output of TAC block 611 is supplied as input to convolutional decoder 613 and MLP 615.

Referring to FIG. 6B, magnitude encoder 601 is representative of one or more software, firmware, and/or hardware components capable of encoding a magnitude spectra value 621 by way of convolutional encoding into an encoded magnitude 623. ITD encoder 603 is representative of one or more software, firmware, and/or hardware components capable of transforming an ITD value 622 along with a target sound source direction 624 into a direction embedding 626. Concatenation block 605 is representative of one or more software, firmware, and/or hardware components capable of concatenating an encoded magnitude 623 and a direction embedding 626 into an embedding sequence 627.

RNN 609 is representative of a recurrent neural network, implemented in software, firmware, and/or hardware, capable of taking an embedding sequence 627 as input and outputting a processed embedding 621. RNN 609 may be a bidirectional long short-term memory (BLSTM) neural network capable of modeling the relation between embeddings of retrieved subjects by applying BLSTM to embedding sequences.

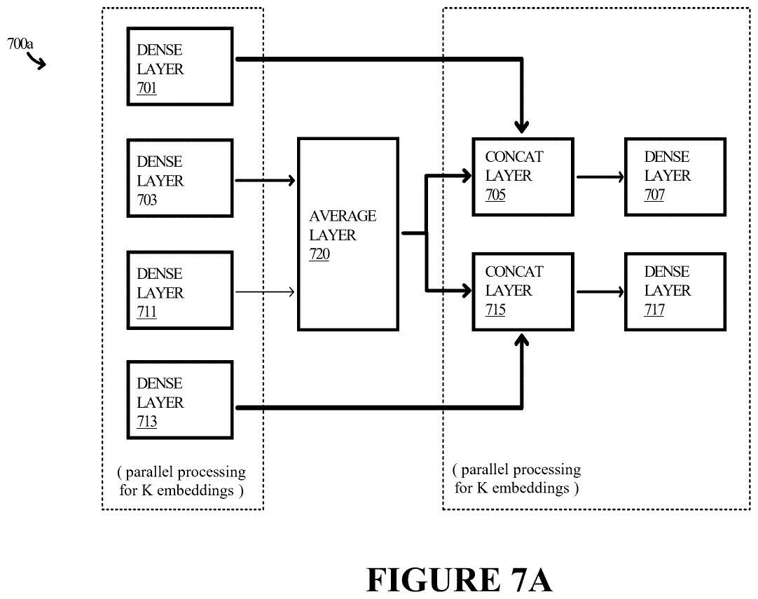

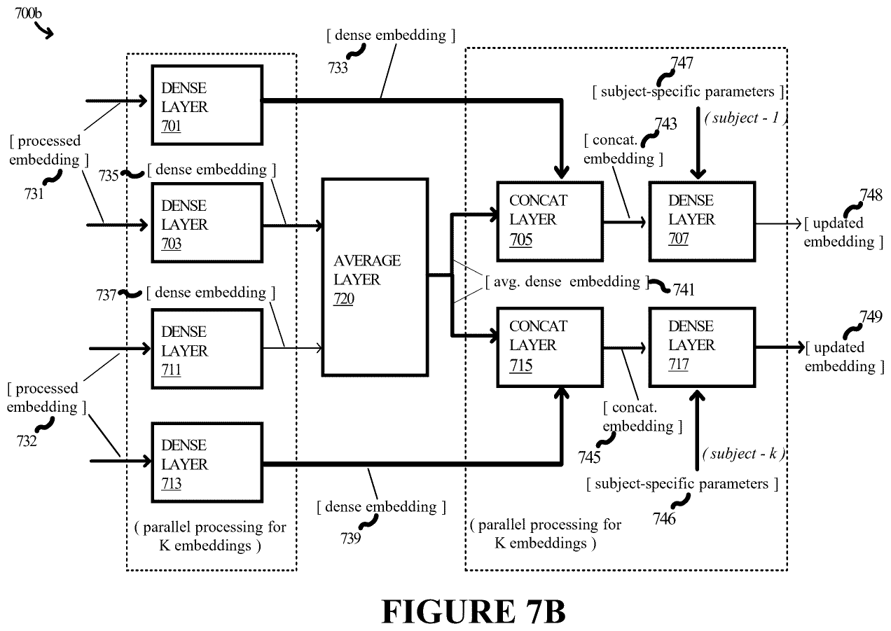

TAC block 611 is also representative of one or more software, firmware, and/or hardware components capable of aggregating information from the processed embeddings of multiple retrieved subjects produced by RNN 609. TAC block 611, discussed in more detail below with respect to FIG. 7, utilizes subject-specific parameters 631 when processing embeddings, and outputs a predicted HRTF that includes a magnitude embedding 633 and an ITD embedding 634.

Convolutional decoder 613 is representative of one or more software, firmware, and/or hardware blocks capable of processing a magnitude embedding 633 to produce a magnitude spectra value 635 that can be used to configure an audio filter. MLP 615 is representative of one or more software, firmware, and/or hardware blocks capable of processing an ITD embedding 634 to produce an ITD value 636 that may also be used to configure an audio filter. The audio filter converts anechoic audio signals to spatialized audio signals.

FIG. 7A illustrates transform-average-concatenate (TAC) architecture 700 in an embodiment that is representative of a suitable architecture for implementing TAC block 611. The elements of TAC architecture 700 may each be implemented in software or firmware executed by the circuitry of one or more processing devices on a single computing device or distributed across multiple computing devices. Alternatively, or in addition, some or all of the functionality provided by any of the elements of network architecture 700 may be implemented entirely via application-specific integrated circuits or other special purpose processing devices.

TAC architecture 700 includes multiple fully connected neural network layers, represented by dense layers 701, 703, 711, and 713. TAC architecture also includes an average layer 720, multiple concatenation layers (represented by concatenation layers 705 and 715), and multiple additional dense layers (represented by dense layers 707 and 717). Dense layer 701 is operatively coupled with concatenation layer 705. Dense layer 703 is operatively coupled with average layer 720, as is dense layer 711. Dense layer 713 is operatively coupled with concatenation layer 715. Average layer is operatively coupled with concatenation layers 705 and 715. Concatenation layer 705 is operatively coupled with dense layer 707, while concatenation layer 715 is operatively coupled with dense layer 717. Said coupling may include outputting certain values that are supplied as input to the next element. For example, the output of dense layer 701 is supplied as input to concatenation layer 705, while the output of concatenation layer 705 is supplied as input to dense layer 707.

Referring to FIG. 7B, dense layer 701 is representative of one or more software, firmware, and/or hardware components capable of receiving processed embeddings 731 for a first subject from an RNN layer and/or BLSTM output and producing a dense embedding 733. Dense layer 701 is also capable of receiving processed embeddings 731 from an RNN layer and/or BLSTM output and producing a dense embedding 735.

Dense layer 711 is representative of one or more software, firmware, and/or hardware components capable of receiving processed embeddings 732 for another subject (a kth subject) from an RNN layer and/or BLSTM output and producing a dense embedding 737. Dense layer 713 is also capable of receiving processed embeddings 732 from an RNN layer and/or BLSTM output and producing a dense embedding 739.

Average layer 720 is representative of one or more software, firmware, and/or hardware components capable of averaging the dense embeddings produced with respect to multiple subjects, for example dense embedding 735 and dense embedding 737. Average layer 720 outputs an average dense embedding 741 to concatenation layers 705 and 715.

Concatenation layer 705 is representative of one or more software, firmware, and/or hardware components capable of concatenating a dense embedding 733 and an average dense embedding 741 and passing the resulting concatenated embedding 743 to an additional dense layer. Similarly, concatenation layer 715 is capable of concatenating a dense embedding 739 and an average dense embedding 741 and passing the resulting concatenated embedding 745 to an additional dense layer.

Dense layer 707 is representative of one or more software, firmware, and/or hardware components capable of receiving a concatenated embedding 743 and subject specific parameters 747 for the first subject and the target subject and producing an updated embedding 748 for the first subject. Dense layer 717 is also representative of one or more software, firmware, and/or hardware components capable of receiving a concatenated embedding 745 and subject specific parameters 746 for the kth subject and the target subject and producing an updated embedding 749 for that subject.

Various embodiments of the present technology discussed above provide for a wide range of technical effects, advantages, and/or improvements to computing systems and components. For example, various embodiments may include one or more of the following technical effects, advantages, and/or improvements: 1) the non-routine and unconventional dynamic implementation of the interpolation of HRTFs; 2) non-routine and unconventional operations for the training of neural networks; 3) the dynamic transformation of anechoic audio signals into spatialized audio signals; 4) the non-routine and unconventional use of subject-specific parameters to train neural networks to perform spatialized interpolation of HRTFs on a subject-specific basis; and 5) the non-routine and unconventional use of subject-specific parameters during inference to produce HRTFs on a subject-specific basis. In addition, the lower computational complexity of the disclosed interpolation techniques especially applicable in resource constrained environments or any setting in which power conservation is valued.

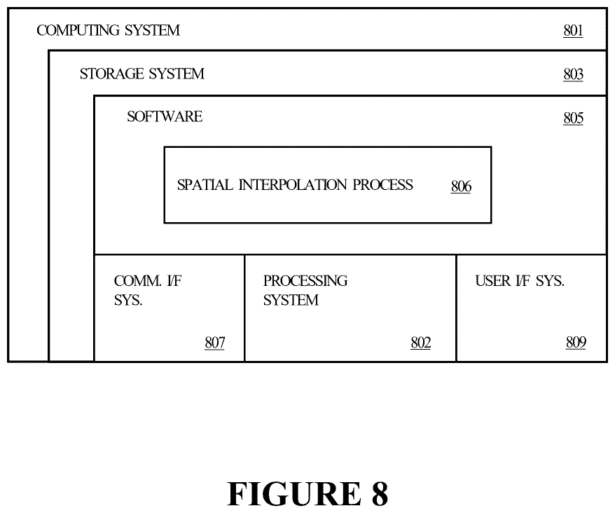

FIG. 8 illustrates computing device 801 that is representative of any system or collection of systems in which the various processes, programs, services, and scenarios disclosed herein may be implemented. Examples of computing device 801 include, but are not limited to, desktop and laptop computers, tablet computers, mobile computers, audio devices, and wearable devices (including headphones, ear buds, and the like). Examples may also include server computers, web servers, cloud computing platforms, and data center equipment, as well as any other type of physical or virtual server machine, container, and any variation or combination thereof.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes and implements spatial interpolation process 806, which is representative of audio processing method 200 and training method 400. When executed by processing system 802, software 805 directs processing system 802 to operate as described herein for at least the various processes, operational scenarios, and sequences discussed in the foregoing implementations. Computing device 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, digital signal processors, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including spatial interpolation process 806) may be implemented in program instructions and among other functions may, when executed by processing system 802, direct processing system 802 to operate as described with respect to the various operational scenarios, sequences, and processes illustrated herein. For example, software 805 may include program instructions for implementing the inference and training processes described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to perform inference and/or training in an optimized manner. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the disclosure is not limited to the specific embodiments described above, but only by the claims and their equivalents.

What is claimed is:

1. An audio processing method, wherein the method uses a processor coupled with stored instructions implementing the method, wherein the instructions, when executed by the processor, carry out steps of the method, comprising:
identifying a target sound source direction and a reference head related transfer function (HRTF) associated with a target subject;
obtaining one or more retrieved HRTFs from an HRTF dataset based at least on the reference HRTF and the target sound source direction;
executing a neural field model to produce an output based on an input, wherein the input comprises the one or more retrieved HRTFs and the target sound source direction, and wherein the output comprises a predicted HRTF; and
processing an anechoic audio signal based at least on the predicted HRTF to produce a spatialized audio signal for the target subject.

2. The method of claim 1 wherein the one or more retrieved HRTFs comprise multiple HRTFs associated with multiple other subjects, and wherein the method further comprises generating the input, including by, for each retrieved HRTF of the multiple HRTFs:
performing a convolutional encoding of a magnitude spectra component of the retrieved HRTF, resulting in an encoded magnitude;
transforming an interaural time difference (ITD) component of the retrieved HRTF and the sound source direction into a direction embedding; and
concatenating the encoded magnitude and the direction embedding to produce an embedding sequence for the retrieved HRTF.

3. The method of claim 2 wherein obtaining the one or more retrieved HRTFs from the HRTF dataset comprises obtaining the one or more retrieved HRTFs based at least on a magnitude spectra component of the reference HRTF, an ITD component of the reference HRTF, and the target sound source direction.

4. The method of claim 2 wherein the neural field model comprises a recurrent neural network (RNN) layer, a transform-average concatenate (TAC) layer, a convolutional decoder, and a multi-layer perceptron (MLP).

5. The method of claim 4 wherein executing the neural field model comprises, for each of the multiple HRTFs:
executing the RNN layer with respect to the embedding sequence, resulting in a processed embedding;
executing the TAC layer with respect to the processed embedding, resulting in an updated embedding;
executing the convolutional decoder with respect to the updated embedding, resulting in a magnitude spectra component of the second HRTF; and
executing the MLP with respect to the updated embedding, resulting in an ITD component of the second HRTF.

6. The method of claim 5 wherein the TAC layer comprises multiple dense layers, an average layer, a concatenation layer, and an additional dense layer, and wherein executing the TAC layer with respect to the processed embeddings comprises:
executing a first one of the multiple dense layers with respect to the processed embedding, resulting in a first dense embedding;
executing a second one of the multiple dense layers with respect to the processed embedding, resulting in a second dense embedding;
executing the average layer with respect to the first dense embedding and other first dense embeddings produced with respect to others of the multiple HRTFs, resulting in an average dense embedding;
executing the concatenation layer with respect to the second dense embedding and the average dense embedding, resulting in a concatenated embedding; and
executing the additional dense layer with respect to the concatenated embedding and based on subject-specific parameters, resulting in the updated embedding.

7. The method of claim 1 further comprising training the neural field model based at least in part on the HRTF dataset, wherein the HRTF dataset comprises multiple collected HRTFs for multiple subjects.

8. The method of claim 7 wherein each collected HRTF in the HRTF dataset comprises a subject identity (ID) corresponding to a measured subject, a measured sound source direction, and measured components, and wherein the measured components comprise a measured magnitude spectra component and a measured ITD component.

9. A memory having program instructions stored thereon for processing audio, wherein the instructions, when executed by one or more processors of a computing device, direct the computing device to at least:
identify a target sound source direction and a reference head related transfer function (HRTF) associated with a target subject;
obtain one or more retrieved HRTFs from an HRTF dataset based at least on the reference HRTF and the target sound source direction;
execute a neural field model to produce an output based on an input, wherein the input comprises the one or more retrieved HRTFs and the target sound source direction, and wherein the output comprises a predicted HRTF; and
process an anechoic audio signal based at least on the predicted HRTF to produce a spatialized audio signal for the target subject.

10. The memory of claim 9 wherein, to obtain the one or more retrieved HRTFs from the HRTF dataset, the program instructions direct the computing device to obtain the one or more HRTFs based on a magnitude spectra component of the reference HRTF, an interaural time difference (ITD) component of the reference HRTF, and the target sound source direction.

11. The memory of claim 10 wherein the HRTF dataset comprises multiple collected HRTFs for multiple subjects, and wherein each collected HRTF in the HRTF dataset comprises a subject identity (ID), a measured sound source direction, and measured components.

12. A computing device comprising:
one or more computer readable storage media;
one or more processors operatively coupled with the one or more computer readable storage media; and
program instructions stored on the one or more computer readable storage media that, when executed by the one or more processors, direct the computing device to at least:
identify a target sound source direction and a reference head related transfer function (HRTF) associated with a target subject;
obtain one or more retrieved HRTFs from an HRTF dataset based at least on the reference HRTF and the target sound source direction;
execute a neural field model to produce an output based on an input, wherein the input comprises the one or more retrieved HRTFs and the target sound source direction, and wherein the output comprises a predicted HRTF; and
produce a spatialized audio signal for the target subject based on an anechoic audio signal and at least on the predicted HRTF.

13. The computing device of claim 12 wherein the one or more retrieved HRTFs comprise multiple HRTFs associated with multiple other subjects, and wherein the program instructions further direct the computing device to generate the input, including by, for each retrieved HRTF of the multiple HRTFs:
performing a convolutional encoding of a magnitude spectra component of the retrieved HRTF, resulting in an encoded magnitude;
transforming an ITD component of the retrieved HRTF and the target sound source direction into a direction embedding; and
concatenating the encoded magnitude and the direction embedding to produce an embedding sequence for the retrieved HRTF.

14. The computing device of claim 13 wherein, to obtain the one or more retrieved HRTFs from the HRTF dataset, the program instructions direct the computing device to obtain the one or more retrieved HRTFS based on a magnitude spectra component of the reference HRTF, an interaural time difference (ITD) component of the reference HRTF, and the target sound source direction.

15. The computing device of claim 14 wherein the neural field model comprises a recurrent neural network (RNN) layer, a transform-average concatenate (TAC) layer, a convolutional decoder, and a multi-layer perceptron (MLP).

16. The computing device of claim 15 wherein to execute the neural field model, the program instructions direct the computing device to, for each of the multiple HRTFs:
execute the RNN layer with respect to the embedding sequence, resulting in a processed embedding;
execute the TAC layer with respect to the processed embedding, resulting in an updated embedding;
execute the convolutional decoder with respect to the updated embedding, resulting in a magnitude spectra component of the second HRTF; and
execute the MLP with respect to the updated embedding, resulting in an ITD component of the second HRTF.

17. The computing device of claim 16 wherein the TAC layer comprises multiple dense layers, an average layer, a concatenation layer, and an additional dense layer, and wherein, to execute the TAC layer with respect to the processed embeddings, the program instructions direct the computing device to:
execute a first one of the multiple dense layers with respect to the processed embedding, resulting in a first dense embedding;
execute a second one of the multiple dense layers with respect to the processed embedding, resulting in a second dense embedding;
execute the average layer with respect to the first dense embedding and other first dense embeddings produced with respect to others of the multiple HRTFs, resulting in an average dense embedding;
execute the concatenation layer with respect to the second dense embedding and the average dense embedding, resulting in a concatenated embedding; and
execute the additional dense layer with respect to the concatenated embedding and based on subject-specific parameters, resulting in the magnitude-related embedding and the ITD-related embedding.

18. The computing device of claim 12 wherein the neural field model is trained at least in part on the HRTF dataset, wherein the HRTF dataset comprises multiple collected HRTFs for multiple subjects, and wherein each collected HRTF in the HRTF dataset comprises a subject identity (ID) corresponding to a measured subject, a measured sound source direction, and measured components, and wherein the measured components comprise a measured magnitude spectra component and a measured ITD component.

19. The computing device of claim 12 wherein the spatialized audio signal comprises a dual-channel audio signal, the reference HRTF comprises a first magnitude spectra component and a first interaural time difference (ITD) component, wherein the second HRTF comprises a second magnitude spectra component and a second ITD component.

20. The computing device of claim 19 wherein, to produce the spatialized audio signal for the target subject, the program instructions direct the computing device to at least:
convert the first magnitude spectra component into a first finite impulse response (FIR) filter, and convert the second magnitude spectra component into a second finite impulse response (FIR) filter;
shift the first FIR filter based on the first ITD component, resulting in a first shifted FIR filter, and shift the second FIR filter based on the second ITD component, resulting in a second shifted FIR filter;
convolve the first shifted FIR filter with the anechoic audio signal in order to produce a first channel of the dual-channel audio signal; and
convolve the second shifted FIR filter with the anechoic audio signal in order to produce a second channel of the dual-channel audio signal.
